(19) United States
(12) Patent Application Publication
(10) Pub. No.: US 2019/0145130 A1
(43) Pub. Date: May 16, 2019

(54) Compact Electronic and Manual Lock Drive System

(71) Applicant: SIVLS Inc., Calgary (CA)

(72) Inventors: Majed Affan, Calgary (CA); Nestorius Wiegandt, Hamburg (DE)

(21) Appl. No.: 15/810,078

(22) Filed: Nov. 12, 2017

(51) Int. Cl. E05B 47/00; E05B 17/22; E05B 63/00; E05B 47/02; E05C 1/00

(52) U.S. Cl. CPC E05B 47/0012; E05B 17/22; E05B 55/12; E05B 47/02; E05C 1/004; E05B 63/0056

(57) ABSTRACT

The present invention is an electronic and manual lock drive system providing both motorized and manual operation of a door lock. The electronic drive system has a compact design and can be mostly fit in the through-door space. It is combined with manual operation module using a lever for moving the deadbolt. The coupling and decoupling of the electromechanical drive system and the manual operation module is achieved by an offset in the rotational axis of the driving gear and the lever handle rotation as well as clutch elements located on the gear and the lever handle. The electronic and manual drive system also comprises a function to provide inform on the state of the lock. This is accomplished by using a pair of sensor switches.

### REFERENCE TO RELATED APPLICATIONS

This is a first-filed invention.

### BACKGROUND OF THE INVENTION

The present invention is in the technical field of electrically operated door locks. More particularly, the present invention relates to a drive apparatus for motor and manual operation of door locks.

Many designs of remote-controlled electronic door locks have been developed to provide convenience and security to users. Usually the electrical operation of a door lock involves extending and retracting a latch bolt or a deadbolt of the door lock using a motorized mechanism. In many products, the motorized mechanism of an electronic door lock is combined with traditional mechanisms using a key cylinder and door knobs/handles, so that the users have the option to lock and unlock using a key or by turning a door knob/handle. In addition, it is desirable to inform the user of the state of the lock (locked or unlocked) using indicators on the device or wirelessly transmitting the information to the user device such as a smart phone. Although various approaches have been developed to combine these different mechanisms and functions in a single device, most systems involve many mechanical and electronic components resulting in a bulky module on either side of the door.

Therefore, it is desirable to develop a multi-functional and easy-to-install electronic lock drive system that is also compact in design.

### SUMMARY OF THE INVENTION

The objective of the present invention to provide an easy-to-install and compact electronic and manual lock drive system which provide both motorized and manual operation of the lock.

In one aspect of the present invention, the lock system comprises an electromechanical drive system that can retract and extend a deadbolt of a door lock using a motor and gears. The electromechanical drive system has a compact design and can be mostly fit in the through-door space. The module installed on the door surface mainly comprises a lever and a battery chamber and can have a sleek and compact design.

In another aspect of the present invention, the electromechanical drive system works with a key cylinder and is combined with manual operation module using a lever for moving the deadbolt. This offers the user the options of operating the lock using a key at one side of the door or by turning a mechanical lever at the other side of the door. The coupling and decoupling of the electromechanical drive system and the manual operation module is achieved by an offset in the rotational axes of the driving gear the lever handle rotation as well as clutch elements located on the gear and the lever handle.

In yet another aspect of the present invention, the electronic and manual drive system comprises a function to provide inform on the state of the lock. This is accomplished by using a pair of sensor switches.

The above invention aspects will be made clear in the drawings and detailed description of the invention.

### BRIEF DESCRIPTION OF THE DRAWINGS

An embodiment of the present invention will now be described, by way of example only, with reference to the following drawings, in which:

FIG. 1 is a perspective view of an embodiment of the electronic and mechanical drive system working with a key cylinder and deadbolt door lock.

FIG. 2 is a perspective view of a partial assembly of the embodiment in FIG. 1 showing the module visible on one side of the door.

FIG. 3 is a perspective view of a partial assembly showing the arrangement of the lever module, the deadbolt module, and the key cylinder.

FIG. 4 is a perspective view of a partial assembly with the key cylinder module and a few covers/housings removed.

FIG. 5 is a perspective view of a partial assembly showing the motor, the gears, the lever handle and sensor switches.

FIG. 6 is a perspective view of a partial assembly showing the arrangement of the lever handle and the back panel gear cover.

FIG. 7 is a perspective view of a partial assembly showing the arrangement of the gears and the lever handle.

FIG. 8 is a perspective view of the lever handle.

FIG. 9 is a perspective view of the internal spur gear with two gear clutch elements.

FIG. 10A is an overall and enlarged projection view of the arrangement of the lever handle and the spur gears when the lever handle and the internal spur gears are decoupled.

FIG. 10B is a perspective view of FIG. 10A.

FIG. 11A is an overall and enlarged projection view of the arrangement of the lever handle and the spur gears when the lever handle and the internal spur gears are coupled.

FIG. 11B is perspective view of FIG. 11A.

In the drawings, the reference numerals are listed below:
1 Deadbolt housing
2 Deadbolt
3 Deadbolt shaft
4 Deadbolt lever
6 through-door housing
8 Key cylinder
9 Key cylinder shaft
13 DC Motor
14 Back panel motor support
17 back panel gear cover
17A Raised cylindrical feature
17B Raised cylindrical feature
18 Internal spur gear
18A Gear clutch element
18B Gear clutch element
19 Motor spur gear
20 Lever handle
20A Lever handle clutch element
20B Lever handle clutch element
23 Back panel anchor
24A Sensor switch
24B Sensor switch
25 PCB
27 back panel LED
31 Bluetooth module
32 Battery
36 Battery housing
37 Battery back cover
38 Lever
41 Key cylinder housing
141 Front LED indicator
137 Back LED indicator

### DETAILED DESCRIPTION OF THE INVENTION

In the detailed description, numerous specific details are set forth in order to provide a thorough understanding of the invention. However, it will be understood by those skilled in the art that these are specific embodiments, and that the present invention may be practiced also in different ways that embody the characterizing features of the invention as described herein. Additionally, some well-known structures or functions may not be shown or described in detail, so as to avoid unnecessarily obscuring the relevant description of the various embodiments.

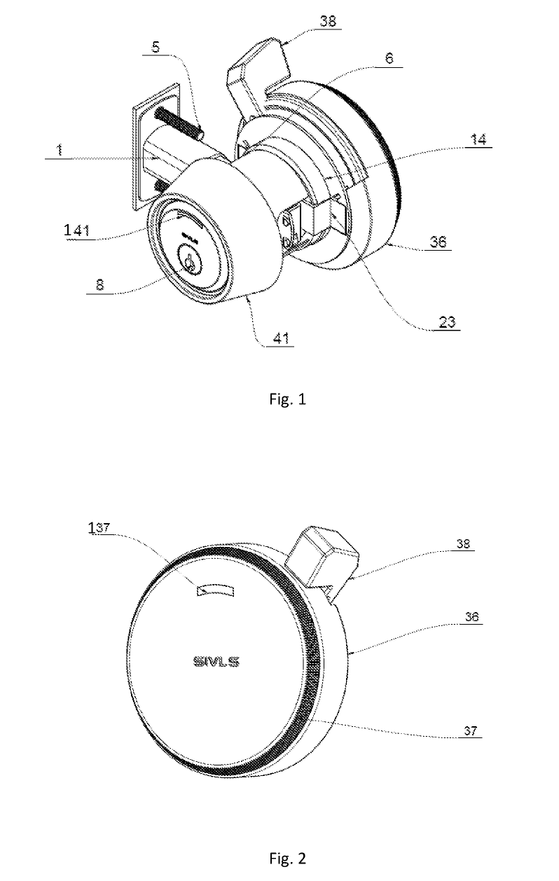

FIG. 1 illustrates an embodiment of the electronic and mechanical drive system working with a key cylinder and deadbolt door lock. In this assembly, the key access portion, including the key cylinder 8 and key cylinder housing 41, is installed on one side of the door (door not shown in this figure). There is a front LED (light emitting diode) indicator 141 on the front face of the key cylinder housing 41. This can be used to indicate the state of the lock. The deadbolt module, including the deadbolt housing 1 which houses additional deadbolt components, is installed on the door frame with deadbolt screws 5.

The key access portion is connected to a through-door portion housed by a through-door housing 6. This portion is installed inside of the door and contains most of the electronic drive components to electrically drive the deadbolt.

In FIG. 1, visible next to the through-door portion is the back panel motor support 14 and the battery housing 36. A lever 38 extends outward between the back panel motor support 14 and the battery housing 36 and may rotate in the range allow by the slot between them. A back panel anchor 23 is made of metallic material and reinforces the plastic parts including the back panel motor support 14.

FIG. 2 shows the module installed on the side of the door other than the key access portion. Since most of the electronic drive components are located in the through-door portion, only a compact battery chamber, including the battery housing 36 and the battery back cover 37, as well as the lever 38 are visible on the other side of the door. There is a back LED indicator 137 on battery back cover 37 to indicate the state of the lock.

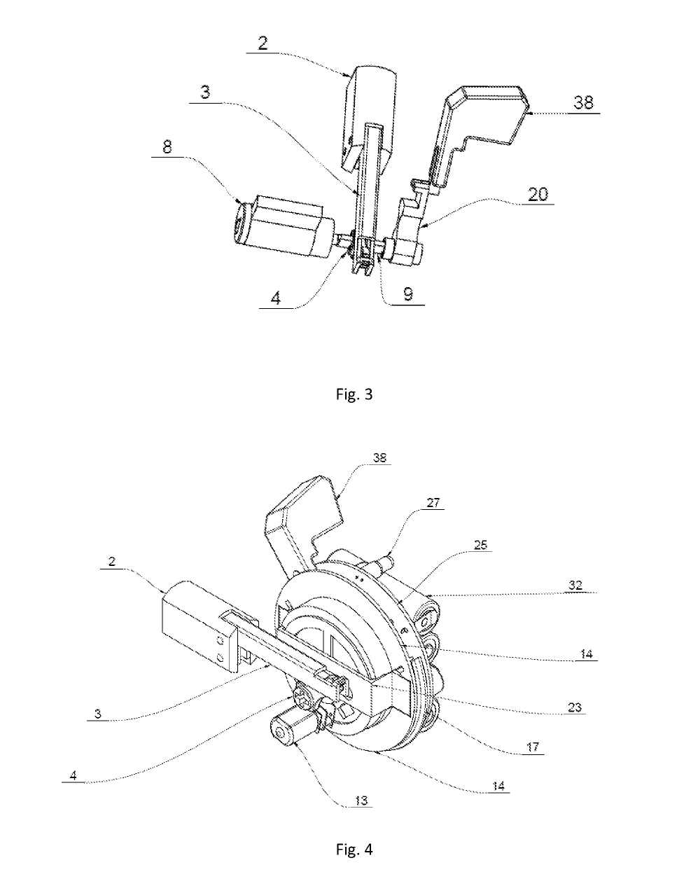

One of the functions of the lever 38 is to manually turn the deadbolt. This function is illustrated in partial assembly in FIG. 3. The lever 38 is connected to a lever handle 20, which is in turn connected to one end of a key cylinder shaft 9. The key cylinder shaft 9 is connected to the key cylinder 8 at the other end, and is also mechanically coupled to the deadbolt 302 via a deadbolt lever 304 and a deadbolt shaft 303. As a result, the deadbolt 302 can be turned to extend and retract by using a key matched to the key cylinder 8 at one side of the door or by manually turning the lever 38 at the other side of the door.

FIG. 4 shows a partial assembly of the embodiment of FIG. 1. Here, the key access module as well as a few covers and housing structures are removed to show additional internal structures. A geared DC motor 13 is mounted on a back panel motor support 14. The back panel motor support 14 along with the back panel gear cover 17 cover and secure and guide the gears, the lever 38, and the motor 13 to provide electronic and manual control of the deadbolt. The reinforcing back panel anchor 23 can be visualized more clearly in this figure. A PCB (printed circuit board) 25 situates behind the back panel motor support 14 and comprises additional electronic components including a back panel LED 27 and is powered by batteries 32.

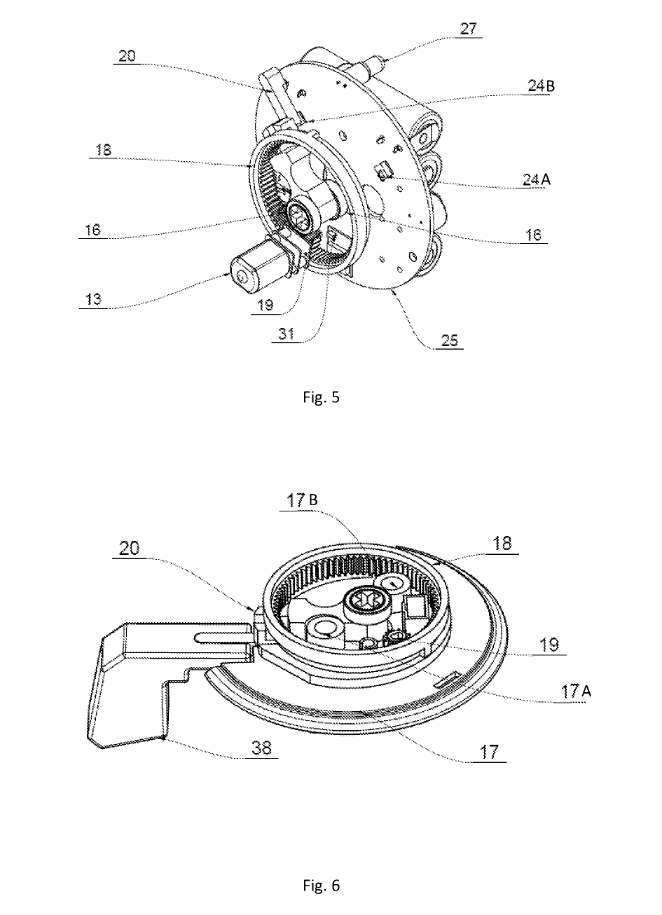

In FIG. 5, the back panel motor support 14 and the panel gear cover 17 are removed to show additional components. The motor 13 is coupled to a motor spur gear 19, which couples to an internal spur gear 18 with a larger diameter. The internal spur gear is mechanically engaged to the lever handle 20. Additional components mounted on the PCB 25 include a Bluetooth module 31 and two sensor switches 24A and 24B. The Bluetooth module 31 pairs and communicates with external wireless devices to receive signal to lock/unlock the door or to send information on the state of the lock to the external device. The Bluetooth module 31 may also provide additional control functions to the electronic driving system to eliminate the needs for an additional onboard CPU (central processing unit). The sensor switches 24A and 24B are detector switches. The are triggered when the underside of the lever handle 20 contacts and glides over the switch. Since the lever handle 20 is connected to the deadbolt 2 through the key cylinder shaft 9, the deadbolt lever 304, and the deadbolt shaft 303 (as shown in FIG. 3), the positions of the sensor switches 24A and 24B detect either end-position of the lever 38 and thus the open and close positions of the deadbolt 2. The state of the lock can be displayed using indicators on the device (such as the front LED indicator 141 and back LED indicator 137) or wirelessly transmitting the information to the user device such as a smart phone.

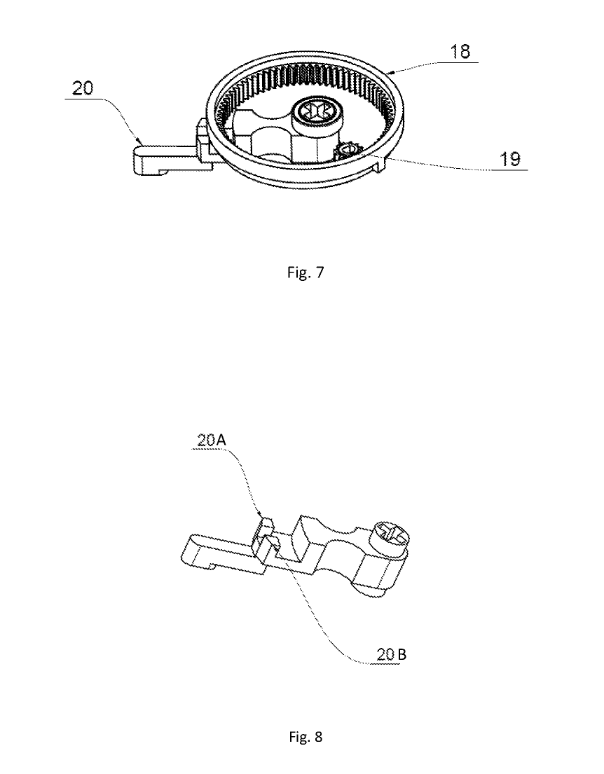

The partial assembly in FIG. 6 includes back panel gear cover 17 and shows the arrangement of the lever handle 20 on the back panel gear cover 17. FIG. 7 shows the partial assembly of the motor spur gear 19, the internal spur gear 18, and the lever handle 20. When the lock is electrically operated, the motor 13 drives the motor spur gear 19 and thus rotates the coupled internal spur gear 18. The internal spur gear 18 in turn drives the lever handle 20 via a coupling mechanism. However, when the lock is manually operated with the lever 38, the internal spur gear 18 needs to be decoupled from the lever handle 20. The coupling and decoupling between the internal spur gear 18 and the lever handle 20 are achieved by an offset in the rotational axis of internal spur gear 18 and the lever handle 20 as well as clutch elements located on both components.

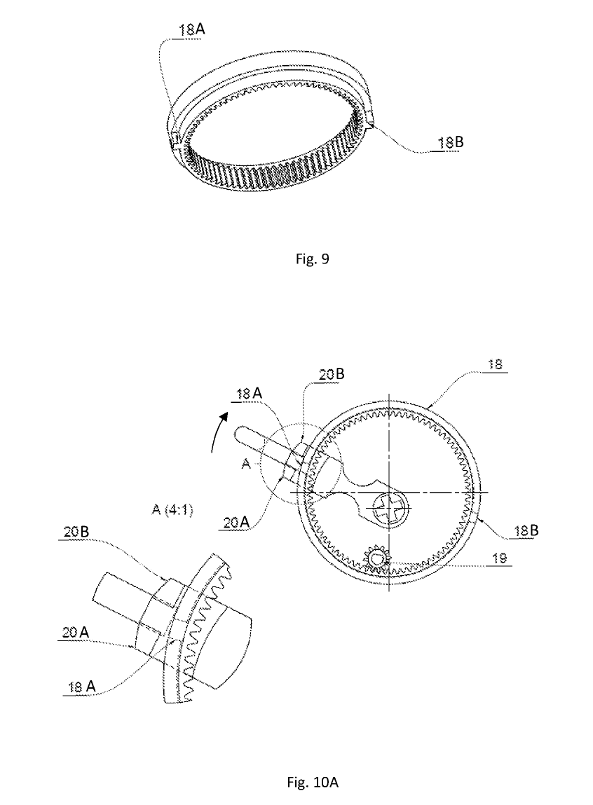

FIG. 8 shows the shape of the lever handle 20 with the lever handle clutch elements 20A and 20B. These clutch elements are symmetrically aligned and point towards the rotational axis. FIG. 9 shows an internal spur gear 18 with 2 spur gear clutch elements 18A and 18B. These clutch elements point away from the rotational axes. The number of spur gear clutch elements can be varied in a range from 1-3. A smaller number of spur gear clutch elements allows more room for the system to decouple.

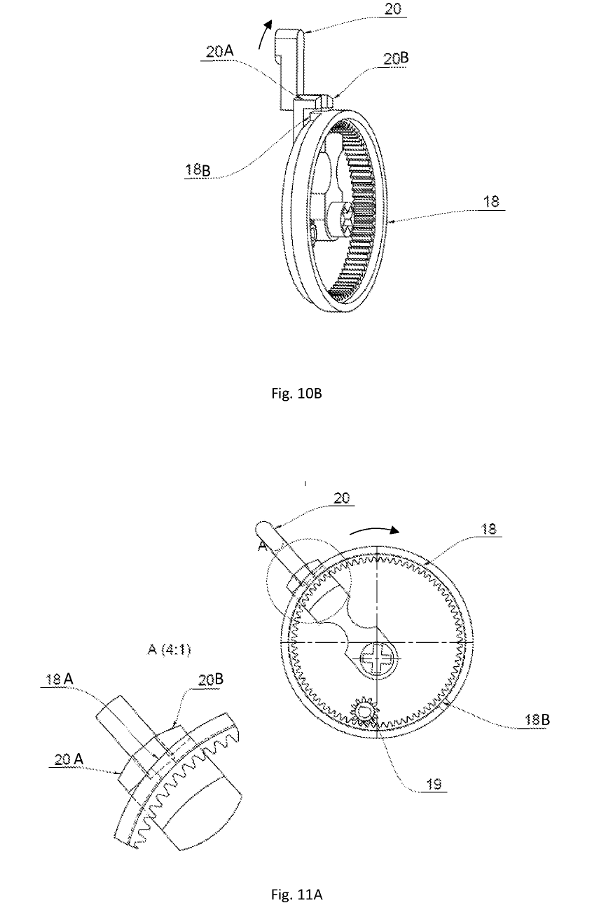

FIGS. 10A and 10B show a relative position of the lever handle 20 and internal spur gear 18 when the lever 38 is being manually rotated to the clockwise direction. Note that the rotational axes of internal spur gear 18 and the lever handle 20 are offset in their position so the circumferential trace of the clutch elements on lever handle 20 and internal spur gear 18 only intersect in about half of both upper quadrants. In the instance shown in FIGS. 10A and 10B, the lever handle 20 and internal spur gear 18 are decoupled. This layout allows that in idle position all clutch elements of the internal spur gear 18 are outside of the possible travel of the clutch elements of the lever handle 20, therefore the lever handle 20 can be moved manually in this range without rotating the internal spur gear 18.

When the motor 13 is used to drive the spur gears, one of the clutch elements of the internal spur gear 18 is moved into the range of the lever handle's clutch elements for coupling and therefore moves the lever handle 20 to the other side. After reaching the other end of the lever handle's travel range, the clutch element of the internal spur gear 18 leaves the trajectory of the lever handle's clutch elements, therefore decouples and allows free manual actuation of the lever handle 20. Detector switches 24A and 24B are positioned at the lever handle's 20 end of the travel in order to verify that the end positions are reached and to determine whether the key cylinder shaft 9 and therefore deadbolt 2 are in locking or unlocking position. The motor 13 stops shortly after the end position is detected.

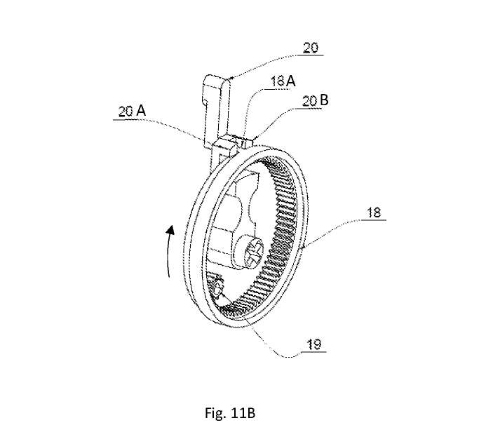

FIGS. 11A and 11B show a relative position of the lever handle 20 and internal spur gear 18 when the internal spur gear 18 is being driven by the motor 13 and motor spur gear 19 to rotate in the clockwise direction. In this case, gear clutch element 18A can pass lever handle clutch element 20A. However, due to the offset in the rotation centers of lever handle 20 and the internal spur gear 18, gear clutch element 18A interferes with the lever handle clutch element 20B, and therefore, the lever handle 20 and internal spur gear 18 are coupled with the clutch elements 20B and 18A. Therefore, the lever handle 20 is driven by the internal spur gear 18 to rotate in the clockwise direction and further drives the movement of the deadbolt 2.

The foregoing description and accompanying drawings illustrate the principles, preferred or example embodiments, and modes of assembly and operation, of the invention; however, the invention is not, and shall not be construed as being exclusive or limited to the specific or particular embodiments set forth hereinabove.

What is claimed is:

1. A lock control and drive assembly, comprising:
an electrical motor;
an electronic control unit to control the electrical motor;
a first spur gear connected to the electrical motor;
a second spur gear coupled to the first spur gear;
a lever unit that can be manually operated to drive a deadbolt or a latch bolt of a lock to extend or withdraw, wherein the lever unit comprises an elongated lever handle, wherein the lever handle is essentially parallel to the plane of the second spur gear, and the lever handle can rotate in a plane parallel to the plane of the second spur gear to drive a deadbolt or a latch bolt of a lock to extend or withdraw;
a means to mechanically couple the second spur gear to the lever handle, so that the second spur gear can drive the lever handle to rotate in a plane parallel to the plane of the second spur gear; and
a means to mechanically decouple the second spur gear from the lever handle, so that manual rotation of the lever handle does not affect the second spur gear.

2. The lock control and drive assembly in claim 1, wherein the means to mechanically couple the second spur gear to the lever handle comprises one or more clutch elements fixed on the second spur gear and one or more clutch elements fixed on the lever handle, and wherein the clutch elements are positioned so that one of the clutch elements on the second spur gear can be brought into contact with one of the clutch elements on the lever handle at a range of relative rotational position between the second spur gear and the lever handle.

3. The lock control and drive assembly in claim 2, wherein the means to mechanically decouple the second spur gear to the lever handle comprises an offset between the rotational axes of the second spur gear and the lever handle so that the clutch elements on the second spur gear is not in contact with the clutch elements on the lever handle at a range of relative rotational position between the second spur gear and the lever handle.

4. The lock control and drive assembly in claim 3, wherein the means to mechanically couple the second spur gear to the lever handle comprises 1-3 clutch elements fixed on the second spur gear and one or more clutch elements fixed on the lever handle, and wherein the clutch elements are positioned so that one of the clutch elements on the second spur gear can be brought into contact with one of the clutch elements on the lever handle at a range of relative rotational position between the second spur gear and the lever handle.

5. The lock control and drive assembly in claim 4, wherein the means to mechanically couple the second spur gear to the lever handle comprises two clutch elements fixed on the second spur gear and at least one clutch elements fixed on the lever handle, and wherein the clutch elements are positioned so that one of the clutch elements on the second spur gear can be brought into contact with one of the clutch elements on the lever handle at a range of relative rotational position between the second spur gear and the lever handle.

6. The lock control and drive assembly in claim 4, wherein the means to mechanically couple the second spur gear to the lever handle comprises 1-3 clutch elements fixed on the second spur gear and two clutch elements fixed on the lever handle, and wherein the clutch elements are positioned so that one of the clutch elements on the second spur gear can be brought into contact with one clutch element on the lever handle while passing the other clutch element on the lever handle at a range of relative rotational position between the second spur gear and the lever handle.

7. The lock control and drive assembly in claim 1, further comprising a means for electronically sensing the state of a lock installed with the lock control and drive assembly.

8. The lock control and drive assembly in claim 7, wherein the means for electronically sensing the state of a lock installed with the lock control and drive assembly comprises a pair of sensors positioned on a plane parallel to the plane of the lever handle's rotation, and wherein either one of the sensors can be triggered when the lever handle rotates to the position where the lever handle touches that sensor.

9. The lock control and drive assembly in claim 8, wherein the sensors are sensing switches.

10. The lock control and drive assembly in claim 7, further comprising one of more visual indicators to indicate the state of a lock installed with the lock control and drive assembly.

11. The lock control and drive assembly in claim 10, wherein the one or more visual indicators comprise one or more LED lights.

12. The lock control and drive assembly in claim 1, further comprising a wireless communication unit that can wirelessly communicate with an external device.

13. The lock control and drive assembly in claim 12, wherein the wireless communication unit comprises a Bluetooth unit.

14. A lock assembly, comprising:
a key cylinder;
a deadbolt;
an electrical motor;
an electronic control unit to control the electrical motor;
a first spur gear connected to the electrical motor;
a second spur gear coupled to the first spur gear;
a lever unit that can be manually operated to drive the deadbolt to extend or withdraw, wherein the lever unit comprises an elongated lever handle, wherein the lever handle is essentially parallel to the plane of the second spur gear, and the lever handle can rotate in a plane parallel to the plane of the second spur gear to drive the deadbolt to extend or withdraw;
a means to mechanically couple the second spur gear to the lever handle, so that the second spur gear can drive the lever handle to rotate in a plane parallel to the plane of the second spur gear; and
a means to mechanically decouple the second spur gear from the lever handle, so that manual rotation of the lever handle does not affect the second spur gear.

15. The lock assembly in claim 14, wherein the means to mechanically couple the second spur gear to the lever handle comprises one or more clutch elements fixed on the second spur gear and one or more clutch elements fixed on the lever handle, and wherein the clutch elements are positioned so that one of the clutch elements on the second spur gear can be brought into contact with one of the clutch elements on the lever handle at a range of the relative rotational position between the second spur gear and the lever handle.

16. The lock assembly in claim 15, wherein the means to mechanically decouple the second spur gear to the lever handle comprises an offset between the rotational axes of the second spur gear and the lever handle so that the clutch elements on the second spur gear is not in contact with the clutch elements on the lever handle at a range of the relative rotational position between the second spur gear and the lever handle.

17. The lock assembly in claim 16, further comprising a means to electronically sensing whether the deadbolt is extended or withdrawn.

18. The lock control and drive assembly in claim 17, wherein the means to electronically sensing whether the deadbolt is extended or withdrawn comprises are a pair of sensing switches positioned on a plane parallel to the plane of the lever handle's rotation, and wherein either one of the sensing switches can be triggered when the lever handle rotates to the position where the lever handle touches that sensing switch.

19. The lock control and drive assembly in claim 18, further comprising a wireless communication unit that can wirelessly communicate with an external device.

20. The lock control and drive assembly in claim 19, wherein the wireless communication unit comprises a Bluetooth unit.
